(19) United States
(12) Patent Application Publication
(10) Pub. No.: US 2003/0180688 A1
(43) Pub. Date: Sep. 25, 2003

(54) Article and method for oral aesthetic enhancement or the like

(76) Inventors: Anthony J. Vocaturo, Freehold, NJ (US); William H. Murphy, Delano, MN (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/105,904

(22) Filed: Mar. 25, 2002

(51) Int. Cl. A61C 5/00

(52) U.S. Cl. 433/215; 433/80

(57) ABSTRACT

An article and a method for oral aesthetic enhancement. The article comprises a resilient arcuate mouth piece having interior surfaces for engaging substantially outwardly facing tooth and gum surfaces of a user and exterior surfaces for abutting the user's gums. A flanged bite extension, located on a selected portion of the interior surfaces, receives the user's teeth. At least one peripheral edge of the piece is ridged for accommodating webbed portions of the user's gum. Mounted to the interior surfaces is a selected absorbent material saturated with a selected composition such that, upon placement of the piece in the user's mouth and engagement of the user's teeth with the bite extension, a selected amount of the absorbed composition is released from the absorbent material for durational contact with the outwardly facing tooth and gum surfaces.

### BACKGROUND OF THE INVENTION

The present invention relates generally to oral aesthetics and, more particularly, to an improved article for enhancing the appearance of teeth, gums and the like.

Conventional methods of providing healthy looking teeth include a regimen of regular brushing using a toothpaste or oral rinse. To aid the cleaning process, a variety of devices have been developed for applying cleansing compositions to and scouring a user's mouth. Such devices have ranged from manual and reciprocating electric toothbrushes to ultrasonic probes. Through frequent brushing, these devices have endeavored to keep the user's teeth free of plaque and other compositions that can decay, stain or otherwise discolor tooth surfaces. Plaque removing rinses and abrasive additive-containing toothpastes are often used in conjunction with these devices to assist in the cleansing process.

While useful for some applications, their consistent and proper use is essential, their effectiveness being substantially dependant on the skill and vigilance of the user. Unfortunately, even the most conscientious and well-trained user often achieves results that are less than desirable. For instance, portions of the teeth are frequently left untreated, leading to spotty discoloration and decay.

Other means for improving one's oral appearance include oral inserts such as bite plates or trays. Typically, these inserts have a trough-like configuration and are shaped like a U for suitably receiving and engaging a user's teeth on interior portions thereof. The trough is constructed of a flexible, thermoplastic material and has a radius of curvature suitable for elastic retention within and about the user's upper and/or lower row(s) of teeth. In addition, the trough is filled, at least in part, with a tooth color-enhancing composition, e.g., fluoride or bleach, desirably to a depth such that those portions of the teeth often visible to the public are immersed in the composition upon engagement of the insert with the user's mouth. By conventional wisdom, the greater the depth of the composition, the more surface area of the teeth that will be covered and, hence, aesthetically improved. Compositions used, in this connection, to effect bleaching have ranged from liquid solutions of perhydrol urea, glycerine and/or potassium citrate to peroxide gels, powders, pastes and other composition of a non-liquid state.

Although useful for treating some visible portions of a user's teeth, this method has been found less effective for treating less frequently seen portions of teeth which are just as vulnerable to decay. This has been found disadvantageous in limiting the potential market for such devices to lower end, tooth bleaching applications. In addition, some user's display a greater portion of their teeth when smiling than others, requiring a greater depth of immersion than is available from existing devices and methods.

An article and method are, therefore, desired for enhancing oral aesthetic appeal that not only provide even and uniform coverage of tooth surfaces with minimal effort of the user, but are also simple, practical, reliable and relatively inexpensive.

### SUMMARY OF THE INVENTION

According to one aspect of the present invention is a resilient article for oral aesthetic enhancement, which comprises an arcuate mouth piece having interior surfaces for engaging substantially outwardly facing tooth and gum surfaces of a user and exterior surfaces for abutting the user's gums, and a flanged bite extension, located on a selected portion of the interior surfaces, for receiving the user's teeth. At least one peripheral edge of the piece is ridged so as to accommodate webbed portions of the user's gum. Mounted to the interior surfaces is a selected absorbent material saturated with a selected composition such that, upon placement of the piece in the user's mouth and engagement of the user's teeth with the bite extension, a selected amount of the absorbed composition is released from the material for durational contact with the outwardly facing tooth and gum surfaces.

In accordance with another aspect of the present invention is a flexible article for oral aesthetic enhancement, which comprises an arcuate mouth piece having interior surfaces for engaging substantially outwardly facing tooth and gum surfaces of a user and exterior surfaces for abutting the user's gums, and a flanged bite extension located on an interior surface thereof for receiving the user's teeth. At least one peripheral edge of the piece is ridged generally at its mid-section for accommodating webbed portions of the user's gum. A foam-like material mounted to the interior surfaces retains a selected fluid such that, upon placement of the piece in the user's mouth and engagement of the user's teeth with the bite extension, a selected amount of the retained fluid is forced from the material into durational contact with the outwardly facing tooth and gum surfaces.

According to a further aspect of the present invention is a flexible article for oral aesthetic enhancement, which comprises a mouth piece having interior surfaces for engaging substantially outwardly facing tooth and gum surfaces of a user and exterior surfaces for abutting the user's gums, and a flanged bite extension located on an interior surface thereof for receiving the user's teeth. At least one peripheral edge of the piece is ridged so as to accommodate webbed portions of the user's gum. Mounted to the interior surfaces is a cloth-like material soaked with a selected fluid such that, upon placement of the piece in the user's mouth and engagement of the user's teeth with the bite extension, a selected volume of fluid is squeezed from the material into durational contact with the outwardly facing tooth and gum surfaces.

In accordance with yet another aspect of the present invention is a resilient article for oral aesthetic enhancement, which comprises an arcuate mouth piece having interior surfaces for engaging substantially outwardly facing tooth and gum surfaces of a user and exterior surfaces for abutting the user's gums. A troughless, flanged bite extension is located on a selected portion of the interior surfaces receives the user's teeth. At least one peripheral edge of the piece is ridged for accommodating webbed portions of the user's gum. Mounted to the interior surfaces is a selected absorbent material saturated with a selected composition such that, upon placement of the piece in the user's mouth and engagement of the user's teeth with the bite extension, a selected amount of the absorbed composition is released from the material into durational contact with the outwardly facing tooth and gum surfaces.

According to another feature of the present invention, a resilient, self-locating article is provided for oral aesthetic enhancement. An arcuate mouth piece is utilized having interior surfaces for engaging substantially outwardly facing tooth and gum surfaces of a user and exterior surfaces for abutting the user's gums. A troughless, flanged bite extension, located on a selected portion of the interior surfaces, receives the user's teeth. At least one peripheral edge of the piece is ridged so as to accommodate webbed portions of the user's gum. In addition, a selected absorbent material mounted to the interior surfaces is saturated with a selected composition such that, upon placement of the piece in the user's mouth and engagement of the user's teeth with the bite extension, a selected amount of the absorbed composition is released from the material for durational contact with the outwardly facing tooth and gum surfaces. The mouth piece is generally shaped such that when placed in a user's mouth, the piece self-locates over the user's teeth with minimal effort and experience of the user.

According to still another aspect of the present invention is a method of oral aesthetic enhancement. Initially, a selected composition for aesthetic enhancement is applied to a resilient article for insertion in a user's oral cavity. The article includes an arcuate mouth piece with interior surfaces for engaging substantially outwardly facing tooth and gum surfaces of a user. The article also has exterior surfaces for abutting the user's gums, the interior surfaces mounting a selected absorbent material for absorbing and retaining the composition. Next, the article is inserted into the user's oral cavity. The article has a curvilinear profile suitable for operative engagement with the user's teeth. Thereafter, the user bites down upon a flanged bite extension located on a selected interior surface of the mouth piece. At least one peripheral edge of the piece is ridged so as to accommodate webbed portions of the user's gum. Upon placement of the piece in the user's mouth and engagement of the user's teeth with the bite extension, a selected amount of the composition retained by the material is released therefrom for durational contact with the outwardly facing tooth and gum surfaces. Finally, after the desired durational contact has been achieved between the outwardly facing tooth and gum surfaces and the composition for aesthetic enhancement, the article is removed from the user's oral cavity.

In accordance with another aspect of the present invention is a method of oral aesthetic enhancement. First, a selected composition for aesthetic enhancement is applied to a resilient article for insertion in a user's oral cavity. The article includes an arcuate mouth piece with interior surfaces for engaging substantially outwardly facing tooth and gum surfaces of a user, and exterior surfaces for abutting the user's gums. The interior surfaces mount a selected absorbent material for receiving and retaining the composition. The article is then inserted into the user's oral cavity, the article having a curvilinear profile for operative engagement with the user's teeth. Next, the user bites down upon a troughless, flanged bite extension located on a selected interior surface of the mouth piece, at least one peripheral edge of the piece being ridged for accommodating webbed portions of the user's gum, such that, upon placement of the piece in the user's mouth and engagement of the user's teeth with the bite extension, a selected amount of the composition retained by the material is released therefrom for durational contact with the outwardly facing tooth and gum surfaces. Finally, after the desired durational contact has been achieved between the outwardly facing tooth and gum surfaces and the composition for aesthetic enhancement, the article is removed from the user's oral cavity.

According to yet a further aspect of the present invention is a method of assembling an article for oral aesthetic enhancement. The method comprises a first step of forming an arcuate mouth piece of a resilient material such that, upon its insertion into a user's oral cavity, interior surfaces of the piece engage substantially outwardly facing tooth and gum surfaces of the user, and exterior surfaces of the piece abut the user's gums; such that a flanged bite extension is located on the interior surface of the mouth piece; and such that at least one peripheral edge of the piece is ridged so as to accommodate webbed portions of the user's gum. Second, a selected absorbent material, for receiving and retaining a selected composition for aesthetic enhancement, is mounted to the interior surfaces. Finally, a selected amount of the composition is applied to the absorbent material such that, upon placement of the piece in the user's mouth and engagement of the user's teeth with the bite extension, a selected amount of the composition retained by the absorbent material is released therefrom for durational contact with the outwardly facing tooth and gum surfaces.

Accordingly, it is an object of the present invention to provide an improved article and method for oral aesthetic enhancement.

Another object of the present invention is to provide oral aesthetic enhancement to the full spectrum of visible portions of a user's teeth.

A further object of the present invention is to provide effective treatment of those portions of teeth seen less frequently but just as vulnerable to decay.

Yet another object of the present invention is to provide consistent treatment and aesthetic enhancement of a user's teeth, regardless of the user and the extent of display of his/her teeth when smiling.

Still another object of the present invention is to eliminate the need for immersing a user's teeth in a composition for achieving desired oral aesthetic enhancement.

Yet a further object of the present invention is to eliminate the need for immersing a user's teeth in a treatment composition and, thereby, applying the composition to portions of teeth that are not seen.

Still a further object of the present invention is to provide an article and method for enhancing oral aesthetic appeal that not only provides even and uniform coverage of tooth surfaces with minimal effort of the user, but are also simple, practical, reliable and economical.

Another object of the present invention is to provide an article in the form of a one-piece unit for oral treatment and aesthetic enhancement which has a design life considerably longer than that of conventional devices for oral treatment.

A further object of the present invention is to provide a practical, reusable, lightweight article for oral treatment and aesthetic enhancement that is safe, durable and reliable.

Yet another object of the present invention is to provide an improved article for oral treatment and aesthetic enhancement that readily fits the contour of a user's teeth and gums.

Still another object of the present invention is to provide an article for oral aesthetic enhancement that effectively treats virtually any visible portion of a user's teeth with minimal skill and vigilance of the user.

Yet a further object of the present invention is to provide an improved article for oral treatment and aesthetic enhancement that is constructed of low cost materials and is easy to store.

Another object of the present invention is to provide an improved article and method of cleaning teeth, gums and the like.

Still another object of the present invention is to provide an article for oral treatment and aesthetic enhancement that is easy to use.

The present invention will now be farther described by reference to the following drawings which are not intended to limit the accompanying claims.

### BRIEF DESCRIPTION OF THE DRAWINGS

FIG. 1 is a perspective view of an article for enhancing oral aesthetic appeal, in an operative position, according to one aspect of the present invention;

FIG. 2 is an perspective view of the article set forth in FIG. 1, in accordance with another aspect of the present invention;

FIG. 3 is a rear plan view of the article set forth in FIG. 1;

FIG. 4 is a front plan view of the article set forth in FIG. 1, operatively positioned in a user's oral cavity, according to the present invention;

FIG. 5 is a top view of the article set forth in FIG. 1;

FIG. 6 is a front plan view of the article set forth in FIG. 1, in a flattened or stowed position;

FIG. 7 is a perspective view of the article mouth piece set forth in FIG. 1, without the absorbent material, having a plurality of ridged portions in the peripheral edge, according to another aspect of the present invention;

FIG. 8 is a plan view of the absorbent material set forth in FIG. 1, with corresponding article shown in phantom according to a flattened or stowed position; and

FIG. 9 is a perspective view of the article mouth piece set forth in FIG. 1 without the absorbent material.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

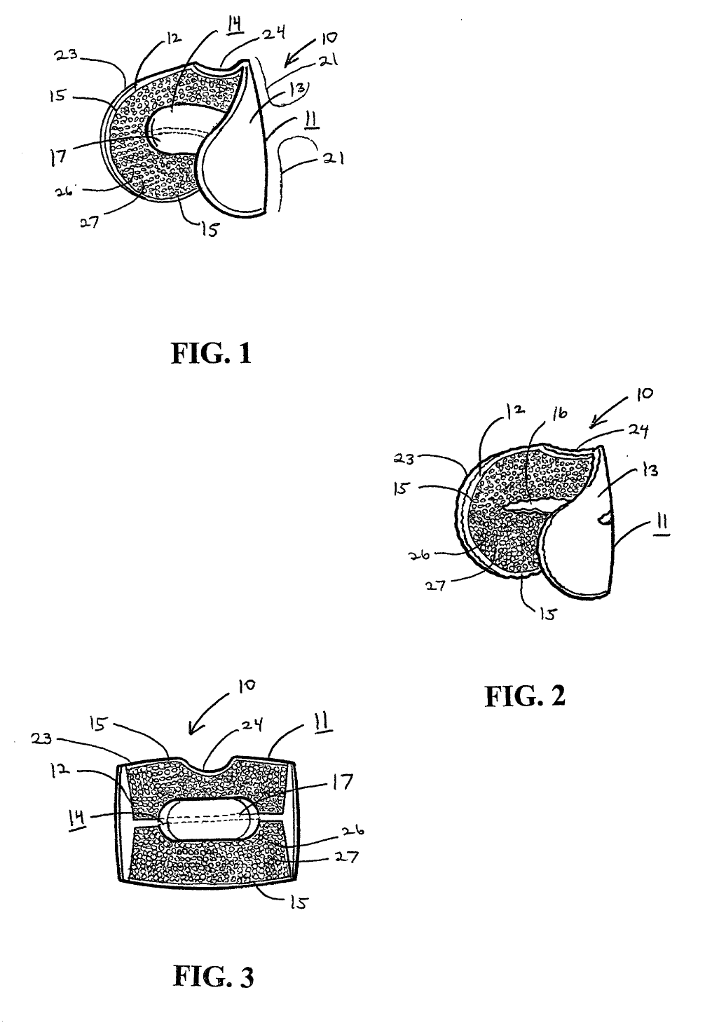

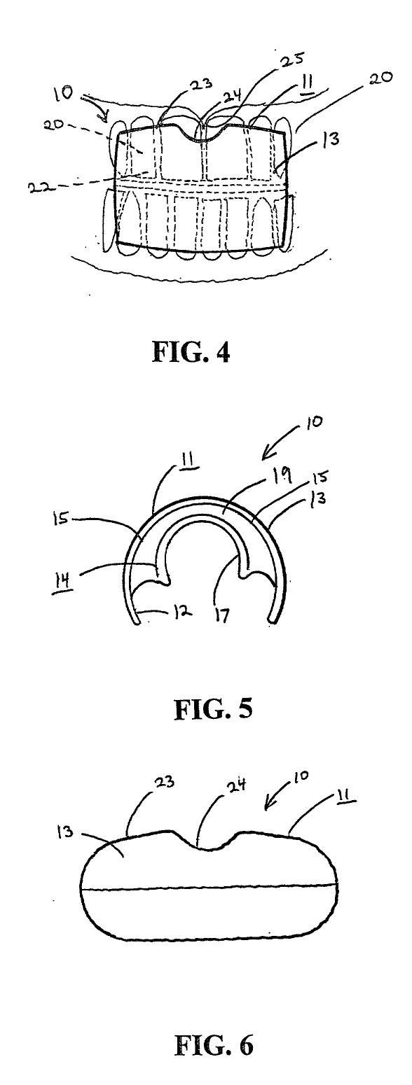

Referring now to the drawings and, more particularly, to FIGS. 1-9, there is shown generally a specific, illustrative article 10 for oral aesthetic enhancement, in accordance with the present invention. According to one aspect of the present invention, as best seen in FIGS. 1 and 5, the article comprises an arcuate mouth piece 11 having interior surfaces 12 for engaging substantially outwardly facing tooth and gum surfaces 20 (See FIG. 4) of a user, and exterior surfaces 13 for abutting the user's gums 21.

A flanged bite extension 14, as illustrated in FIGS. 1, 3 and 5, configured for receiving the user's teeth 22 (FIG. 4) is located on a selected portion 15 of the interior surfaces and protrudes at a selected angle, e.g., a right angle, relative thereto. Preferably, the interior surfaces and flange 17 of the bite extension are separated a selected distance 18 so as to define a troughless, tooth receiving space 19. The bite extension, in this connection, has a suitable thickness, e.g., about 2.1 mm or like geometry, and a width such that the user's jaw is relatively precisely at rest during use. According to one embodiment, 2.1 mm is the approximate width of a typical user's teeth at rest. Alternatively, as shown in FIG. 2, a flangeless bite extension 16 is provided, the extension having like dimensions, in accordance with the present invention. In either case, by keeping the teeth at rest, stress on the user's joint during prolonged use is minimized.

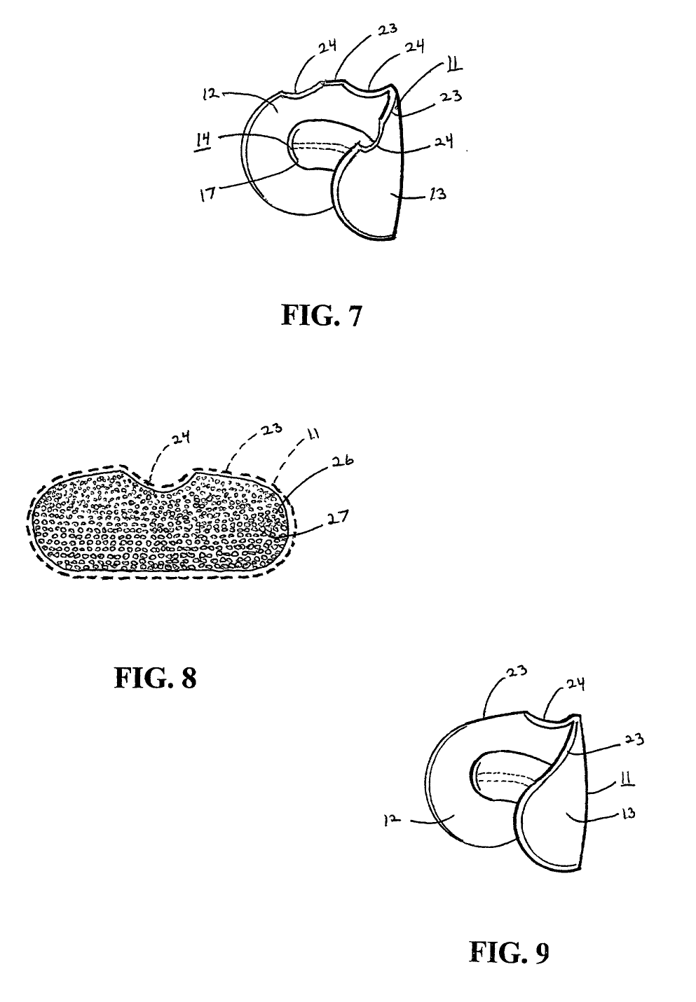

At least one peripheral edge 23 of mouth piece 11 is provided with ridged portions 24 for accommodating webbed portions 25 (See FIG. 4) of the user's gum and, thereby, maintaining breathability by the user during use. Preferably, such ridged portions 24 are located generally at the mouth piece mid-section and correspond to webbed portions of the user's gum on both the upper and lower jaw. Alternatively, as shown in FIG. 7, a plurality of ridges are located in the mouth piece at its mid section and/or throughout the arcuate length thereof for further enhancement of breathing. Moreover, alternatively or concurrently, a slit or a plurality of slits are located in the mouth piece, also at its mid section and/or throughout the arcuate length thereof, for added breathability.

The mouth piece is preferably constructed as a one-piece unit, its radius being desirably smaller than a user's mouth so as to maintain pressure or frictional retention in the user's mouth and against the teeth being treated. It is preferred in this connection, that the mouth piece be made, at least in part, of a flexible and/or resilient material, such that the piece may be sized and is stretchable to suitably fit any user. Accordingly, it is considered desirable the present invention be provided as a one size fits all type unit. It is additionally preferred that the material(s) of choice be a reusable or disposable polymeric. Exemplary materials include, but are not limited to, a copolymer of ethylene and vinyl acetate such as Elvax®, a low density polyethylene, rubber or the like. Especially desirable are commercial grades of vinyl acetate generally within a range of 9 to 40% and having a melt index from about 0.3 to about 500 dg/min.

Elvax® 150 to Elvax® 880 have been found particularly desirable for their ready processing by conventional thermoplastic techniques such as injection molding, structural foam molding, sheet and shape extrusion, blow molding and wire coating. Likewise, these compositions may be processed using well-known techniques including Banbury, two-roll milling and compression molding. They are also useful as a blending resin, improving the flexibility, resilience and toughness of other olefinic resins and rubbers, and is readily compounded with polyethylene, polypropylene, ABS resins, thermoplastic rubbers (SBR and TRP), nitrile rubbers, natural rubber and other elastomers and compounded rubbers.

Preferred material characteristics, according to various aspects of the present invention, include inherent flexibility, resilience, toughness, transparency, non-toxicity and superior resistance to ozone and environmental stress cracking. Notably, flexibility, resilience, toughness and transparency generally increase with rising vinyl acetate content. Other desirable characteristics, for purposes of oral aesthetic enhancement, include the capacity to be readily pigmented, filled, foamed and/or crosslinked. Such variation in material characteristics is considered known by those skilled in the art and further description is believed unnecessary for purposes of illustrating the present invention.

Although the present invention has been shown and described as a single structural unit, it will be understood by those skilled in the art that the article may be multi-structural, comprised of separate and distinct units joined to and/or that fit into one another, giving consideration to the purpose for which the present invention is intended. In addition, each of the units may be suitably constructed of the same material, of different materials or in any combination thereof, within the spirit and scope of the present invention.

Mounted to interior surfaces 12 is a selected absorbent material 26, best seen in FIG. 8, saturated with a selected composition 27 such that, upon placement of the piece in the user's mouth and engagement of the user's teeth with bite extension 14, a selected amount of the absorbed composition is released, e.g., squeezed, from the material for durational contact with the outwardly facing tooth and gum surfaces. More particularly, upon locating the user's teeth in tooth receiving space 19, the size and configuration of the piece compresses the absorbent material, releasing the composition into contact with substantially the entirety of the tooth surfaces.

Desirably, the material is bonded to the interior surface, such as by an acrylic adhesive, the material blanketing the surfaces so as to reach, but not necessarily extend beyond, peripheral or side edges 23 of the piece. Alternatively, the material approaches the side edges, but does not necessarily reach, leaving a relatively bare strip of interior surface for guiding the released composition. Preferred absorbent materials for this application include an open-cell, polyethylene foam, e.g., from DuPont 20 polyethylene resin having a density factor of about 0.920 g/cm³, a similar foam-like material, a natural or synthetic sponge, cloth or the like. The material is covered, wet or soaked with the selected composition to be absorbed and retained, e.g., benzalconium chloride or like bleaching agent, preferably to saturation.

Hence, the configuration of the mouth piece, in conjunction with the material(s) of construction, permit the article to be placed in a user's mouth and generally self-locate itself over the user's teeth with minimal effort and experience of the user. An optimum orientation of the article relative to the teeth, e.g., a right angle, is therefore maintained, consistently and uniformly between the absorbent material and the tooth surfaces throughout the desired region of application. The flexibility and/or resilience of the article, and the location of the bite extension, are also advantageous not only for facilitating insertion of the article in the user's mouth, but also retaining the article in the desired position for optimum treatment or application of the composition.

Generally speaking, the article shape and material are considered relatively important for effective chemical treatment of teeth and gums, according to the various aspects of the present invention. Since the dimensions of the mouth piece are relatively small, its configuration allows more pressure to be applied, and more uniformly to the tooth surfaces for maximum coverage of tooth surfaces and optimum application of treatment composition without discomfort. Hence, the present invention provides an ideal combination of ease of manufacture, use and effectiveness.

Although the present invention has been shown and described in connection with applying bleaching agents, it will be understood by those skilled in the art that other suitable compositions may be utilized effectively, giving consideration to the purpose for which the present invention is intended. For example, the absorbent material used may be soaked and/or saturated with fluoride suspended in liquid, paste or gel form, within the spirit and scope of the present invention.

For instance, the present invention, according to a further embodiment, has been found suitable for administering a dentifrice comprising selected compounds of fluoride or the like to the oral cavity, e.g., for fluoride treatment. Compositions of this general description are set forth in U.S. Pat. No. 6,346,235 entitled “Dual Component Dentifrice Composition for Fluoridating Teeth”, which issued on Feb. 12, 2002, the disclosure of which is hereby incorporated by reference in its entirety. Administration of such compositions is desirably enhanced with the aid of durational contact, such as that exhibited upon use of the present invention.

Turning now to use of the present invention, in one embodiment, a method is provided for oral aesthetic enhancement. Initially, selected composition 27 for aesthetic enhancement, e.g., fluoride and/or a bleaching agent, is applied to resilient article 10 for insertion in a user's oral cavity. The article includes arcuate mouth piece 11 with interior surfaces 12 for engaging substantially outwardly facing tooth and gum surfaces of a user. The article also has exterior surfaces 13 for abutting the user's gums, the interior surfaces mounting a selected absorbent material 26 for absorbing and retaining the composition. Next, the article is inserted into the user's oral cavity, the article having a curvilinear profile, as illustrated in FIG. 5, suitable for operative engagement with the user's teeth. Thereafter, the user bites down upon flanged bite extension 14 located on the selected mouth piece interior surface. At least one peripheral edge 23 of the piece is ridged 24 for accommodating webbed portions 25 of the user's gum.

Upon placement of the piece in the user's mouth and engagement of the user's teeth with the bite extension, the material is compressed, thereby releasing a selected amount of composition 27 retained by the material into durational contact with the outwardly facing tooth and gum surfaces. Finally, after the desired durational contact has been achieved, i.e., between the outwardly facing tooth and gum surfaces and the composition for aesthetic enhancement, the article is removed from the user's oral cavity.

In accordance with another aspect of the present invention is an alternative method of oral aesthetic enhancement. First, the selected composition for aesthetic enhancement is applied to a flexible article for insertion in a user's oral cavity. The article includes the arcuate mouth piece with interior surfaces for engaging substantially outwardly facing tooth and gum surfaces of a user, and exterior surfaces for abutting the user's gums. The interior surfaces, as before, mount the selected absorbent material for receiving and retaining the composition. The article is then inserted into the user's oral cavity, the article having a curvilinear profile for operative engagement with the user's teeth. Next, the user bites down upon the troughless, flanged bite extension located on the selected mouth piece interior surface. Again, the peripheral edge of the piece is ridged, preferably at its mid section, for accommodating webbed portions of the user's gum.

As before, upon placement of the piece in the user's mouth and engagement of the user's teeth with the bite extension, the material is compressed, thereby releasing a selected amount of the composition retained by the material is released into durational contact with the outwardly facing tooth and gum surfaces. Finally, after the desired durational contact has been achieved between the outwardly facing tooth and gum surfaces and the composition for aesthetic enhancement, the article is removed from the user's oral cavity.

A further benefit of the present invention relates to its ease and economy of manufacture. According to one feature, in this connection, is a method of assembling an article for oral aesthetic enhancement. Initially, the arcuate mouth piece is formed, such as by extrusion molding, with the flanged bite extension protruding from the interior surface thereof for insertion into a user's oral cavity. The piece is constructed of a durable, flexible and/or resilient material such that interior surfaces of the piece engage substantially outwardly facing tooth and gum surfaces of a user. Next, at least one peripheral edge of the piece is ridged for accommodating webbed portions of the user's gum. The selected absorbent material is then mounted to the interior surfaces for absorbing and retaining the selected composition for aesthetic enhancement. Finally, the composition in a selected amount is applied to the absorbent material such that, upon placement o f the piece in the user's mouth and engagement of the user's teeth with the bite extension, the material is compressed, thereby releasing the composition retained by the material into durational contact with the outwardly facing tooth and gum surfaces.

Overall, the present invention advantageously provides a novel mouth piece configuration, flexible and/or resilient construction and absorbent material which, in combination, facilitate optimum chemical treatment of a user's teeth, consistently, effectively, reliably and uniformly. Its flexibility and/or resilience as well as the position of the bite extension are not only beneficial for enabling ready insertion of the article in the user's mouth, but also for self-locating and retaining the article in the desired position for optimum but safe treatment or application of the chemical treatment composition. Moreover, the present invention provides an improved combination that is simple to use and manufacture as well as effective for oral aesthetic enhancement.

In this manner, superior, practical and inexpensive treatment is provided of those portions of teeth seen less frequently but just as vulnerable to discoloration and/or decay, regardless of the skill and vigilance of the user.

Various modifications and alterations to the present invention may be appreciated based on a review of this disclosure. These changes and additions are intended to be within the scope and spirit of this invention as defined by the following claims.

What is claimed is:

1. A resilient article for oral aesthetic enhancement, which comprises:
an arcuate mouth piece having interior surfaces for engaging substantially outwardly facing tooth and gum surfaces of a user and exterior surfaces for abutting the user's gums;
a flanged bite extension, located on a selected portion of the interior surfaces, for receiving the user's teeth, at least one peripheral edge of the piece being ridged so as to accommodate webbed portions of the user's gum; and
a selected absorbent material mounted to the interior surfaces and saturated with a selected composition such that, upon placement of the piece in the user's mouth and engagement of the user's teeth with the bite extension, a selected amount of the absorbed composition is released from the material for durational contact with the outwardly facing tooth and gum surfaces.

2. The article set forth in claim 1 wherein the mouthpiece is a one piece unit.

3. The article set forth in claim 1 wherein the resilient material is a reusable polymeric material.

4. The article set forth in claim 1 wherein the absorbent material is an open-cell, polyethylene foam.

5. The article set forth in claim 1 wherein the article is constructed, at least in part, of ethylene vinyl acetate.

6. A flexible article for oral aesthetic enhancement, which comprises:
an arcuate mouth piece having interior surfaces for engaging substantially outwardly facing tooth and gum surfaces of a user and exterior surfaces for abutting the user's gums;
a flanged bite extension, located on a selected portion of the interior surfaces, for receiving the user's teeth, at least one peripheral edge of the piece being ridged generally at its mid-section for accommodating webbed portions of the user's gum; and
a foam-like material mounted to the interior surfaces retaining a selected fluid such that, upon placement of the piece in the user's mouth and engagement of the user's teeth with the bite extension, a selected amount of the retained fluid is forced from the material into durational contact with the outwardly facing tooth and gum surfaces.

7. The article set forth in claim 6 wherein the mouthpiece is a one piece unit.

8. The article set forth in claim 6 wherein the resilient material is a reusable polymeric material.

9. The article set forth in claim 6 wherein the absorbent material is an open-cell, polyethylene foam.

10. The article set forth in claim 6 wherein the article is constructed, at least in part, of ethylene vinyl acetate.

11. A flexible article for oral aesthetic enhancement, which comprises:
a mouth piece having interior surfaces for engaging substantially outwardly facing tooth and gum surfaces of a user and exterior surfaces for abutting the user's gums;
a flanged bite extension, located on a selected portion of the interior surfaces, for receiving the user's teeth, at least one peripheral edge of the piece being ridged for accommodating webbed portions of the user's gum; and
a cloth-like material mounted to the interior surfaces and soaked with a selected fluid such that, upon placement of the piece in the user's mouth and engagement of the user's teeth with the bite extension, a selected volume of the soaked fluid is squeezed from the material into durational contact with the outwardly facing tooth and gum surfaces.

12. The article set forth in claim 11 wherein the mouthpiece is a one piece unit.

13. The article set forth in claim 11 wherein the resilient material is a reusable polymeric material.

14. The article set forth in claim 11 wherein the absorbent material is an open-cell, polyethylene foam.

15. The article set forth in claim 11 wherein the article is constructed, at least in part, of ethylene vinyl acetate.

16. A resilient article for oral aesthetic enhancement, which comprises:
an arcuate mouth piece having interior surfaces for engaging substantially outwardly facing tooth and gum surfaces of a user and exterior surfaces for abutting the user's gums;
a troughless, flanged bite extension, located on a selected portion of the interior surfaces, for receiving the user's teeth, at least one peripheral edge of the piece being ridged so as to accommodate webbed portions of the user's gum; and
a selected absorbent material mounted to the interior surfaces and saturated with a selected composition such that, upon placement of the piece in the user's mouth and engagement of the user's teeth with the bite extension, a selected amount of the absorbed composition is released from the material for durational contact with the outwardly facing tooth and gum surfaces.

17. A resilient article for oral aesthetic enhancement, which comprises:
an arcuate, self-locating mouth piece having interior surfaces for engaging substantially outwardly facing tooth and gum surfaces of a user and exterior surfaces for abutting the user's gums;
a troughless, flanged bite extension, located on a selected portion of the interior surfaces, for receiving the user's teeth, at least one peripheral edge of the piece being ridged so as to accommodate webbed portions of the user's gum; and
a selected absorbent material mounted to the interior surfaces and saturated with a selected composition such that, upon placement of the piece in the user's mouth and engagement of the user's teeth with the bite extension, a selected amount of the absorbed composition is released from the material for durational contact with the outwardly facing tooth and gum surfaces;
the mouth piece being generally shaped such that when placed in a user's mouth, the piece self-locates over the user's teeth with minimal effort and experience of the user.

18. A method of oral aesthetic enhancement, which comprises the steps of:
i. applying a selected composition for aesthetic enhancement to a resilient article for insertion in a user's oral cavity, the article including an arcuate mouth piece with interior surfaces for engaging substantially outwardly facing tooth and gum surfaces of a user, and exterior surfaces for abutting the user's gums, the interior surfaces mounting a selected absorbent material for receiving and retaining the composition;
ii. inserting the article into the user's oral cavity, the article having a curvilinear profile for operative engagement with the user's teeth;
iii. biting down by the user upon a flanged bite extension located on a selected interior surface of the mouth piece, at least one peripheral edge of the piece being ridged for accommodating webbed portions of the user's gum, such that, upon placement of the piece in the user's mouth and engagement of the user's teeth with the bite extension, a selected amount of the composition retained by the material is released for durational contact with the outwardly facing tooth and gum surfaces; and
iv. after the desired durational contact has been achieved between the outwardly facing tooth and gum surfaces and the composition for aesthetic enhancement, removing the article from the user's oral cavity.

19. A method of oral aesthetic enhancement, which comprises the steps of:
i. applying a selected composition for aesthetic enhancement to a resilient article for insertion in a user's oral cavity, the article including an arcuate mouth piece with interior surfaces for engaging substantially outwardly facing tooth and gum surfaces of a user, and exterior surfaces for abutting the user's gums, the interior surfaces mounting a selected absorbent material for receiving and retaining the composition;
ii. inserting the article into the user's oral cavity, the article having a curvilinear profile for operative engagement with the user's teeth;
iii. biting down by the user upon a troughless, flanged bite extension located on a selected interior surface of the mouth piece, at least one peripheral edge of the piece being ridged for accommodating webbed portions of the user's gum, such that, upon placement of the piece in the user's mouth and engagement o f the user's teeth with the bite extension, a selected amount of the composition retained by the material is released therefrom for durational contact with the outwardly facing tooth and gum surfaces; and
iv. after the desired durational contact has been achieved between the outwardly facing tooth and gum surfaces and the composition for aesthetic enhancement, removing the article from the user's oral cavity.

20. A method of assembling an article for oral aesthetic enhancement, the method comprising the steps of:
i. forming an arcuate mouth piece of a resilient material such that, upon its insertion into a user's oral cavity, interior surfaces of the piece engage substantially outwardly facing tooth and gum surfaces of the user, and exterior surfaces of the piece abut the user's gums, such that a flanged bite extension is located on the interior surface of the mouth piece, and such that at least one peripheral edge of the piece is ridged so as to accommodate webbed portions of the user's gum;
ii. mounting a selected absorbent material to the interior surfaces, the material absorbing and retaining a selected composition for aesthetic enhancement; and
iii. applying a selected amount of the composition to the material such that, upon placement of the piece in the user's mouth and engagement of the user's teeth with the bite extension, a selected amount of the composition retained by the material is released into durational contact with the outwardly facing tooth and gum surfaces.
